(19) United States
(12) Patent Application Publication
(10) Pub. No.: US 2010/0250756 A1
(43) Pub. Date: Sep. 30, 2010

(54) Methods, Systems, And Computer Program Products For Establishing A Shared Browsing Session Between A User Of A Web Browser With A User Of Another Web Browser

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/414,835

(22) Filed: Mar. 31, 2009

(51) Int. Cl. G06F 15/16

(52) U.S. Cl. 709/228

(57) ABSTRACT

Methods and systems are described for establishing a shared browsing session between a user of a web browser with a user of another browser. In one aspect, based on a received activity message sent from a first node, information identifying an association between current browsing information and a using principal of a browser operating on the first node is relayed to a second node. A session initiation message (SIM) is received including a request to establish a co-browsing session with the using principal of the browser. Based on the SIM, the request is relayed to the first node. A session establish message (SEM), sent from the first node, is relayed to the second node to configure the requested shared browsing information. The SEM includes session establishment information for configuring the requested session. Current browser information of the using principal, sent from the first node, is relayed to the second node.

### RELATED APPLICATIONS

This application is related to the commonly owned U.S. patent application Ser. No. ______ (Attorney Docket No. 1543/US) filed on Mar. 31, 2009, entitled “Methods, Systems, And Computer Program Products For Establishing A Shared Browsing Session Between A User Of A Web Browser With A User Of Another Web Browser”, the entire disclosure being incorporated by reference herein.

### BACKGROUND

Co-browsing, in the context of web browsing, is the navigation of the Internet by several people accessing the same web pages at the same time. This can be achieved by communicating to one another the page that is being browsed manually (phone, instant messaging), or with conventional techniques which automatically synchronizes the browsers.

Manual communication requires effort by a user to constantly inform the other user of the web site being browsed. As a user gets engrossed in web browsing, the user often forgets to communicate with the other user. As a result, the co-browsing session is not a productive session and the other user may lose interest and browse on her own.

Conventional techniques typically require a user to create a session and invite other participants to a session. The other participants often do not know or see where the user is currently browsing and accept the invitation without having knowledge of the current browsing activity. As a result, the other participants may not want to accept the invitation.

### SUMMARY

Accordingly, there exists a need for methods, systems, and computer program products for establishing a shared browsing session between a user of a web browser with a user of another web browser.

Methods and systems are described for establishing a shared browsing session between a user of a web browser and a user of another browser. In one aspect, based on a received activity message sent from a first node, information identifying an association between current browsing information and a using principal of a browser operating on the first node is relayed to a second node. A session initiation message is received including a request to establish a co-browsing session with the using principal of the browser. Based on the session initiation message, the request is relayed to the first node. A session establish message, sent from the first node, is relayed to the second node to configure the requested shared browsing information. The session establish message includes session establishment information for configuring the requested co-browsing session. Current browser information of the using principal, sent from the first node, is relayed to the second node.

In another aspect, a system for establishing a shared browsing session between a user of a web browser with a user of another web browser comprises means for relaying, based on a received activity message sent from a first node, information to a second node. The information identifies an association between current browsing information and a using principal of a browser operating on the first node. The system further comprises means for receiving a session initiation message including a request to establish a co-browsing session with the using principal of the browser. The system further comprises means for relaying, based on the session initiation message, the request to the first node. The system further comprises means for relaying a session establish message, sent from the first node, to the second node to configure the requested co-browsing information. The session establish message includes session establishment information for configuring the requested co-browsing session. The system further comprises means for relaying current browser information of the using principal, sent from the first node, to the second node.

In another aspect, a system for establishing a shared browsing session between a user of a web browser with a user of another web browser comprises system components including an activity messenger component, an activity proxy component, a session manager component, and a session messenger component. The activity messenger component is configured to relay, based on an activity message received by the activity proxy component sent from a first node, information to a second node, the information identifying an association between current browsing information and a using principal of a browser operating on the first node. The session manager component is configured to receive a session initiation message including a request to establish a co-browsing session with the using principal of the browser. The session manager component is further configured to relay, based on the session initiation message, the request to the first node. The activity messenger component is further configured to relay a session establish message, sent from the first node, to the second node to configure the requested co-browsing information. The session establish message includes session establishment information for configuring the requested co-browsing session. The session messenger component is configured to relay current browser information of the using principal, sent from the first node, to the second node.

In another aspect, a computer readable medium storing a computer program, executable by a machine, for establishing a shared browsing session between a user of a web browser with a user of another web browser is defined. The computer program comprises executable instructions for relaying, based on a received activity message sent from a first node, information to a second node, the information identifying an association between current browsing information and a using principal of a browser operating on the first node. The computer program comprises further executable instructions for receiving a session initiation message including a request to establish a co-browsing session with the using principal of the browser. The computer program comprises further executable instructions for relaying, based on the session initiation message, the request to the first node. The computer program comprises further executable instructions for relaying a session establish message, sent from the first node, to the second node to configure the requested co-browsing information, the session establish message including session establishment information for configuring the requested co-browsing session. The computer program comprises further executable instructions for relaying current browser information of the using principal, sent from the first node, to the second node.

### BRIEF DESCRIPTION OF THE DRAWINGS

Advantages of the claimed subject matter will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a flow diagram illustrating a method for establishing a shared browsing session between a user of a web browser with a user of another web browser according to an aspect of the subject matter described herein;

FIG. 3 is a block diagram illustrating an arrangement of components for establishing a shared browsing session between a user of a web browser with a user of another web browser according to another aspect of the subject matter described herein;

FIG. 4 is a block diagram illustrating an arrangement of components providing an execution environment configured to host the arrangement of components of FIG. 3;

FIG. 5 is a block diagram illustrating nodes communicating directly with each other to establish a shared browsing session between a user of a web browser with a user of another web browser according to an aspect of the subject matter described herein;

FIG. 6 is a block diagram illustrating nodes communicating with each other through a proxy node to establish a shared browsing session between a user of a web browser with a user of another web browser according to an aspect of the subject matter described herein;

FIG. 7 is a block diagram illustrating nodes communicating with each other through a proxy node and directly to establish a shared browsing session between a user of a web browser with a user of another web browser according to an aspect of the subject matter described herein;

FIG. 8 is a flow diagram illustrating a method for establishing a shared browsing session between a user of a web browser with a user of another web browser according to another aspect of the subject matter described herein;

FIG. 9 is a block diagram illustrating an arrangement of components for establishing a shared browsing session between a user of a web browser with a user of another web browser according to another aspect of the subject matter described herein;

FIG. 10 is a block diagram illustrating an arrangement of components providing an execution environment configured to host the arrangement of components of FIG. 7;

FIG. 11 is an illustration of a display illustrating an embodiment of requesting a shared browsing session according to another aspect of the subject matter described herein;

FIG. 12 is an illustration of a browser graphical user interface presented by one of the nodes in FIGS. 5, 6, and/or 7.

FIG. 13 is a flow diagram illustrating a method for establishing a shared browsing session between a user of a web browser with a user of another web browser according to another aspect of the subject matter described herein;

FIG. 14 is a block diagram illustrating an arrangement of components for establishing a shared browsing session between a user of a web browser with a user of another web browser according to another aspect of the subject matter described herein; and

FIG. 15 is a block diagram illustrating an arrangement of components providing an execution environment configured to host the arrangement of components of FIG. 14.

### DETAILED DESCRIPTION

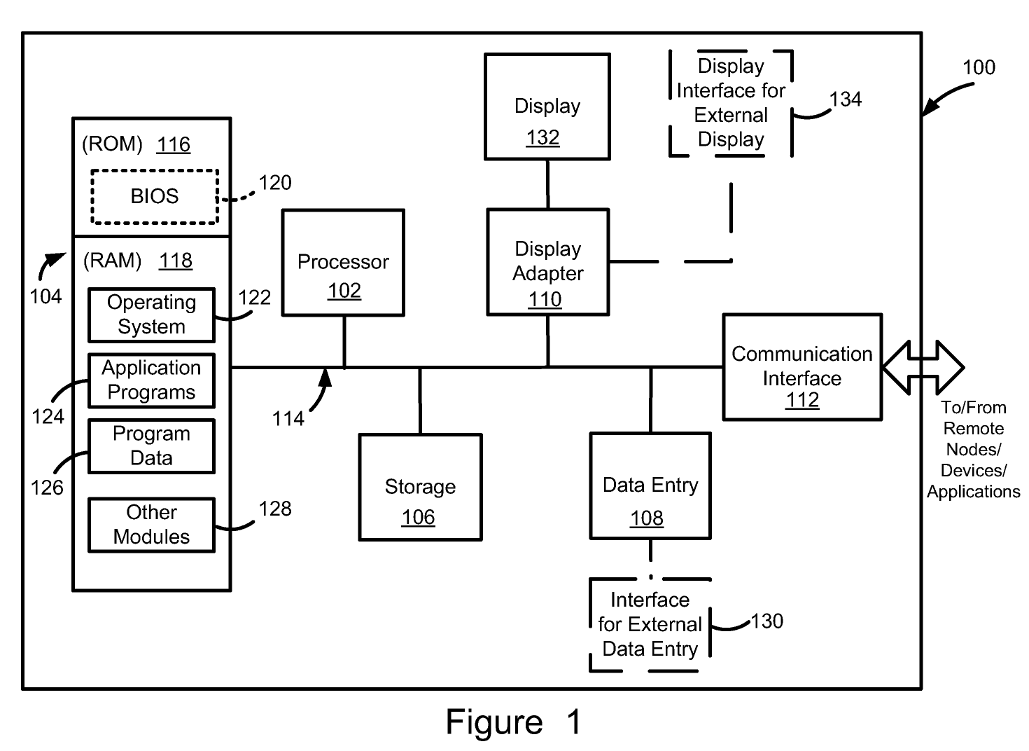

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

One mode of exchanging information over the Internet uses a publish/subscribe (pub-sub), asynchronous, communication protocol. The commands of an asynchronous protocol, such as a pub-sub communication protocol, are structured such that there need not be a one-to-one correspondence between messages exchanged between communication entities. In some cases a publisher of information via the protocol need not wait for, nor expect, a response from a receiver of a message. Moreover, a receiver need not send a request for each message received. That is, a receiver may receive multiple messages associated with a sent message and/or may receive an unsolicited message. Thus, unlike a request/response, synchronous protocol where the response is sent directly (synchronously) and only in response to the entity's request, the information can instead be sent to a receiver in the absence of a corresponding request from the receiver (i.e., asynchronous to any request for information).

According to pub-sub communication protocols, a pub-sub service can receive published information from a publisher and asynchronously deliver such information to receivers. Typically, the pub-sub service stores and organizes such information in a data entity known as a tuple, which in its broadest sense, is a data object containing one or more tuple elements into which information is organized and stored. The information stored in a tuple represents a principal, which can represent a user, a group, an application, an entity, or a device, that owns the tuple. Each tuple can be identified by a tuple identifier (ID), e.g., a uniform resource identifier (URI) or uniform resource locator (URL), and the principal can publish information to its associated tuple using the tuple ID.

An entity interested in receiving information published by a principal can subscribe to the principal's associated tuple by providing the tuple ID. When the principal publishes updated information identifying the tuple to be created or updated, the pub-sub service updates the tuple information and transmits the updated information to all interested entities, i.e., subscribers, via notification messages. The published information can be read simultaneously by any number of subscribers. So long as the subscriber remains subscribed to the tuple, the subscriber can continue to receive notification messages corresponding to the tuple principal's postings. Some pub-sub services can support filters that restrict the set of subscribers to whom updated information is transmitted. Subscribers can be principals.

Notably, as is used herein, the term “publish/subscribe” or “pub-sub” refers to the class of services and associated protocols where a subscribing client knows the tuple identifier, and thus the principal, of the tuple for which a subscription is to be established. Similarly, the publishing client knows the tuple identifier of the tuple to which it is publishing information, and can specify to which watching principals the tuple information should be sent, e.g., in a directed Publish or Notify. The subscriber receives only the most recently published information in a notification message resulting from a subscription. That is, the pub-sub service transmits to the subscriber only the most current state of the published information in response to new and/or updated tuple information.

By way of example, aspects of an embodiment described here can employ a presence protocol as the pub-sub communications protocol. It should be understood, however, the relevant techniques described here can be performed using any pub-sub communications protocol as defined herein. Additionally, the exemplary embodiment described herein is not limited to the use of a pub-sub protocol for all communications described. Other known protocols can also be used.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence,” each of which are published and owned by the Internet Society and are hereby incorporated by reference in their entirety. A pub-sub protocol, as defined herein, includes any protocol meeting the requirements for a presence protocol as specified in RFC 2779 with the exception that there are no requirements for the content of a pub-sub tuple. That is, a pub-sub tuple is not required to support any particular content, such as status and contact means, as required by RFC 2779 for a presence protocol. Publish and notify messages identify the updated tuple and thus identify the publishing principal. Subscribe messages identify the subscriber.

Generally speaking, one or more service nodes are used to provide pub-sub services. The function of a service node, however, can be incorporated, either in whole or in part, into other entities. For example, the pub-sub model described to support presence services in RFC 2778 describes two distinct agents of a presence or pub-sub service client. The first of these agents, called a “presentity” (combining the terms “presence” and “entity”), provides pub-sub information, such as presence information, to be stored and distributed throughout the pub-sub service on behalf of a pub-sub client. The second type of agent is referred to as a “watcher.” Watchers receive pub-sub information, such as presence information, from a pub-sub service on behalf of a pub-sub client.

Users of the pub-sub service are referred to, in the model described in RFC 2778, as principals. Typically, a principal is a person or group that exists outside of the presence model. A principal can also be a software component, a hardware component, or other resource capable of being represented by the pub-sub service. A principal can interact with or otherwise be represented by the pub-sub system through a “pub-sub user agent” (PUA) referred to in RFC 2778 as a “presence user agent” (PUA) or a “watcher user agent” (WUA). As in the case of the presentity and watcher clients with which these service clients interact, the presence and watcher user agents can be combined functionally as a single user agent having both the characteristics of the presence and watcher user agents. User agents can be implemented such that their functionality exists within a pub-sub service, external to a pub-sub service, or a combination of both. Similar statements can be made about presentities and watchers.

As mentioned above, a pub-sub service typically stores and organizes published information into tuples. A tuple can represent any element used to store the published information associated with a resource, e.g., a publisher/principal. The published information may include general contact information for the network resource, such as a name, a telephone number, an email address, a postal address, and IP addresses or uniform resource locators (URLs) associated with the resource, and the like, as well as other data or content. As used here, the tuple can also be a representation that maps field names to certain values to indicate that an entity or object (e.g., the principal) includes certain components, information, and/or perhaps has certain properties.

In contrast to other services, the pub-sub services as described herein are not topic, class, or content based subscription services, which are typically included in message-oriented middleware (MOM) subscription services. Topic, class, and content based subscription systems are referred to in this document as MOM subscription services. In MOM subscription services, sometimes also referred to as pub-sub services, publishers do not publish to identified tuples, nor do subscribers subscribe to tuples of identified principals. Publishers and subscribers can be anonymous. Depending on the variant of this type of service, publishers publish information to nowhere in particular allowing the service to examine the content of the information, and distribute it to subscribers based on content filters included in their subscriptions to an identified topic, an identified class, and/or an identified type. More particularly, MOM subscription services do not send their messages to specific receivers, but instead characterize messages by topic, class, or content without knowledge of what (if any) subscribers there may be. Subscribers express interest in a topic, class, or content, and only receive messages that are of interest, without knowledge of what (if any) publishers there are. While sometimes referred to as pub-sub services, such MOM subscription services do not fall within the scope of the pub-sub services described herein.

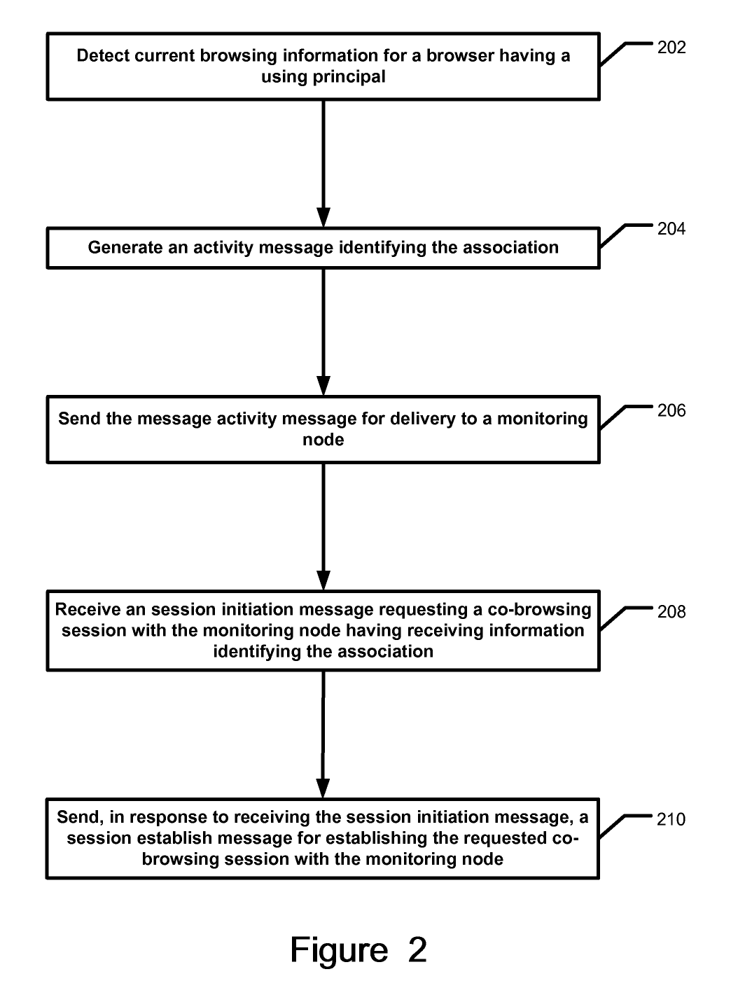

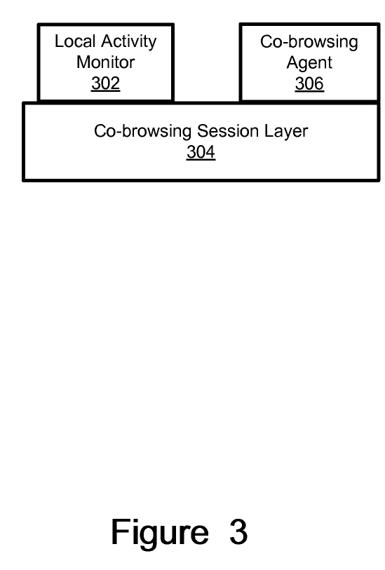

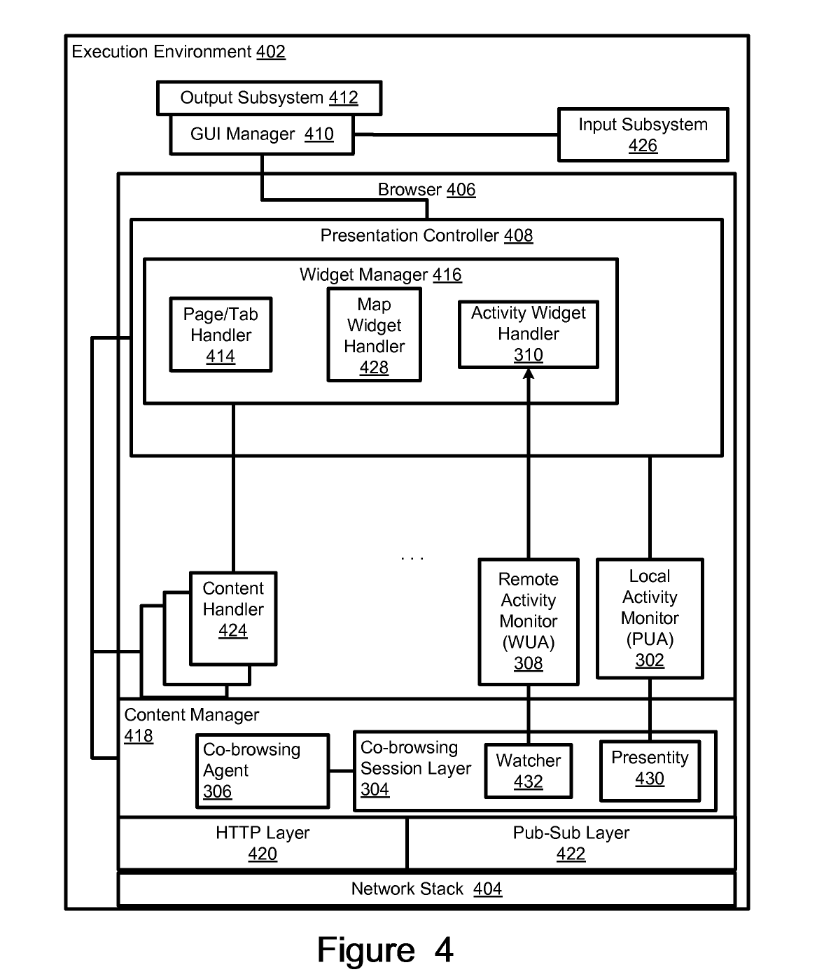

Turning now to FIG. 2, a flow diagram is illustrated illustrating a method for establishing a shared browsing session between a user of a web browser with a user of another web browser according to an exemplary aspect of the subject matter described herein. FIG. 3 is a block diagram illustrating an arrangement of components for establishing a shared browsing session between a user of a web browser with a user of another web browser according to another exemplary aspect of the subject matter described herein. FIG. 4 is a block diagram illustrating an arrangement of components providing an execution environment configured for hosting the arrangement of components depicted in FIG. 3. The method in FIG. 2 can be carried out by, for example, some or all of the components illustrated in the exemplary arrangement in FIG. 3 operating in an a compatible execution environment, such as the environment provided by some or all of the components of the arrangement in FIG. 4. The arrangement of components in FIG. 4 may be implemented by some or all of the components of the hardware device 100 of FIG. 1.

The components illustrated in FIG. 3 can be adapted for performing the method illustrated in FIG. 2 in a number of execution environments, such as the exemplary execution environment 402 illustrated in FIG. 4. FIG. 1 illustrates key components of an exemplary device that can host the exemplary execution environment 402. The components illustrated in FIG. 3 and FIG. 4 can be part of the components of FIG. 1 and/or separate components of FIG. 1. For example, a network stack 404 can be part of communication interface 112 and/or a separate component in communication with communication interface 112.

FIG. 4 illustrates a browser 406 operating in the execution environment 402. The browser 406 illustrated includes a presentation controller component 408 configured to manage the browser's graphical user interface (GUI) including one or more widget handlers corresponding to one or more widgets presented in the browsers GUI. Presentation controller component 408 is configured to communicate with a GUI manager component 410. The GUI manager component 410 can be configured to present a GUI including one or more widgets on a display, such as the display 132. The GUI manager component 410 can be configured to present a widget via an output subsystem 412 which can include, for example, a graphics library (not shown) providing drawing capabilities, and a device driver (not shown) for communicating with a display adapter (not shown). The device driver and display adapter, such as the display adapter 110 can be configured to provide resources such as memory for storing data for a presentable representation of a widget. The presentable data can be provided to the display for presenting via the display adapter.

As described above, the GUI manager component 410 can include one or more widget handlers such as a page/tab handler 414 configured to present a widget including a presentation space for presenting browsed content. Map widget handler component 428 presents maps in a map widget. The browser 406 in FIG. 4 includes a widget manager 416 that can be configured to manage widget handlers by instantiating, deleting, activating, and/or deactivating widget handlers as required by the configuration of the browser and input received.

As illustrated, the browser 406 includes a content manager component 418 configured to route content received via the network stack 404 and optionally via an application layer interoperating with the network stack 404. An HTTP layer 420 providing support for the Hypertext Transfer Protocol (HTTP) and a pub-sub layer 422 providing support for a publish-subscribe protocol are illustrated in FIG. 4 as exemplary application layer protocols a content manager can be configured to interoperate with for sending and receiving messages via the network stack 404.

The content manager component 418 is configured to route at least a portion of a received message to a content handler component 424 based on a content type of the at least a portion of the message content. Data types are typically indicated as MIME types. Examples of content handler components can include a text/html content handler component for processing HTML documents, an application/xmpp-xml content handler component for processing XMPP streams including presence messages, instant messages, publish-subscribe messages, and request-reply style messages as defined by various XMPP specifications, a video/mpeg content handler component for processing MPEG streams, and an image/jpeg content handler component for processing JPEG images. A content handler component 424 can be configured to process the content including providing a representation of the content to a widget handler, such as a page/tab widget handler component 414 for presentation in a content region of a page/tab widget as described above.

Alternatively and additionally, content manager component 418 can be configured to communication directly with a widget handler component such as a page/tab widget handler component 414, map widget handler component 428, or other widget handler (not shown) in the presentation controller component 408. The widget handler components can be part of the widget manager component 416 as shown and/or can be separate components.

The content manager component 418 can be configured to send messages as directed by a content handler component 424 and/or the presentation controller component 408 and/or its components. For example, a URL can be received via an input subsystem 426 in correspondence with a location bar widget managed by a location bar widget handler (not shown) and/or can be received via link in content presented in a page/tab widget managed by a page/tab widget handler component 414. The content manager component 418 is configured to send messages such as requests for content and/or commands for acting on accessible resources via the network stack 404 optionally in cooperation with one or more application layers, such as the HTTP layer 420 and the pub-sub layer 422. A message can be transmitted over a network via the communication interface 112 interoperating with the network stack 404.

As described above, input including user input and/or input from external components operating in the execution environment can be received via an input subsystem component 426, and provided, for example to the GUI manager component 410 where the GUI manager component 410 can be configured to associate the input with a location/region on the display, for example, based on a position of a mouse pointer. The input subsystem component 426 may be part of data entry component 108 and/or be separate from data entry component 108. The GUI manager component 410 can determine a widget that corresponds to the location on the display. The GUI manager component 410 identifies a widget handler component for processing the input based on the determined widget. The GUI manager component 410 can interoperate with a widget manager component 416 to identify the appropriate widget handler component or provide the input to the appropriate widget handler component without interoperation with the widget manager component 416.

When a map is presented via map widget handler component 428 and the presentation controller component 408, a navigation space handler component (not shown) is configured to receive location information identifying a location on the map being presented. The navigation space handler component can be provided with the resource being presented and/or the map information from the map widget handler component 428. The location information can be included in and/or with the presentable resource. Alternatively or additionally, the location information can be provided in and/or with the map information. The navigation space handler component can be configured to determine the location information based on the presentable resource and/or map information. For example, the navigation space handler component can be configured to invoke a resolver component to resolve a network identifier associated with the presentable resource, such as the network identifier of a resource provider, to a location.

With reference to FIG. 2, in block 202 current browsing information for a browser having a using entity is detected. Accordingly, a system for establishing a shared browsing session between a user of a web browser with a user of another web browser includes means for detecting current browsing information for a browser having a using entity. For example, as illustrated in FIG. 3, a local activity monitor (LAM) component 302 is configured to detect current browsing information for a browser having a using entity.

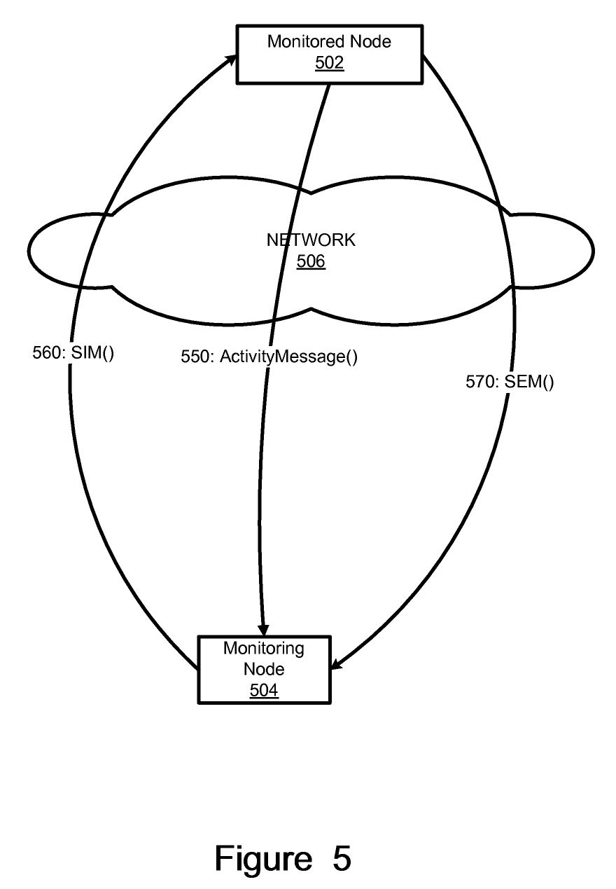

A LAM component 302 can be configured to detect browsing information by intercepting or otherwise detecting input, command invocations, and other events of a browser component 406 hosted by the execution environment 402. The execution environment can be hosted by a monitored node as illustrated in FIGS. 5, 6, and 7 as monitored nodes 502, 602, and 702 respectively.

The browsing information detected can indicate or otherwise relate to the activity of a using entity such as a user of the browser 406. The LAM component 302 is shown as detecting browsing information via the presentation controller component 408, which is configured to manage the browser's graphical user interface (GUI) as described above. This is merely exemplary as a LAM component 302 can be configured to interoperate with a browser component for the purpose of detecting browsing information. Additionally and/or alternatively, a LAM component 302 can operate as a component of the browser 406 and/or operate external to a browser.

A LAM component 302 can use any suitable network communication protocol for sharing detected browser information. For example FIG. 4 illustrates that a LAM component 302 can operate as a presence user agent (PUA) in a publish-subscribe (pub-sub) based system. Alternatively a LAM component 302 can include a PUA or interoperate with a PUA as a separate component. In a pub-sub based system the user entity can be a principal represented by a tuple of the pub-sub based system. In some embodiments, current browsing information can be formatted according to a content type and thus a LAM component 302 can be a content handler component 424, a component of a content handler component 424, and/or operate independently of any content handler components.

Returning to FIG. 2, in block 204 an activity message is generated identifying a current activity of the using entity. Accordingly, a system for establishing a shared browsing session between a user of a web browser with a user of another web browser includes means for generating an activity message identifying a current activity of the using entity. For example, as illustrated in FIG. 3, a co-browsing session layer component 304 is configured to generate an activity message identifying a current activity of the using entity.

The LAM component 302 can provide the current browsing information to the co-browsing session layer component 304. In the execution environment illustrated in FIG. 4, the co-browsing session layer component 304 is a component within content manager component 418. This is merely exemplary as a co-browsing session layer component 302 can be configured to operate external to the browser 406. The activity message can be of any suitable format and protocol compatible with the other nodes in the system, such as for example, the nodes 502, 504, 602, 604, 608, 702, 704, 708 illustrated in FIGS. 5, 6, and 7.

In the execution environment illustrated in FIG. 4, a presentity component 430 within the co-browsing session layer component 304 is configured to generate the activity message as a publish command in a pub-sub protocol. The presentity component 430 is illustrated as a component of the co-browsing session layer 304 in FIG. 4. In an alternative embodiment, a presentity can operate as a separate component. Alternatively, a monitored node such as any of the monitored nodes 502, 602, 702, can host a subscription service such as a pub-sub service. The co-browsing session layer component 304 can include or otherwise interoperate with a local subscription service to generate the activity message as a notify message, alert, or other asynchronous message. Alternatively, a monitored node 502, 602, 702 can be polled by a monitoring node 504, 604, 704 and the activity message can be generated as a response in any suitable request-response protocol to the poll or request message. For example, a monitored node can host a web server for receiving HTTP requests and generating HTTP response messages.

Returning to FIG. 2, in block 206 the activity message is sent for delivery to a monitoring node. Accordingly, a system for establishing a shared browsing session between a user of a web browser with a user of another web browser includes means for sending the activity message for delivery to a monitoring node. For example, as illustrated in FIG. 3, the co-browsing session layer component 302 is configured to send the activity message for delivery to a monitoring node. As indicated above the activity message can be of any suitable format and protocol.

For example, the co-browsing session layer component 302 can be configured to send the activity message from the monitored node 502, 602, 702 for delivery to a monitoring node 504, 604, 704. For example, as illustrated in FIG. 5, the activity message 550 can be addressed to the monitoring node 504 and transmitted via a network 506. The activity message 550 can be sent without solicitation from the monitoring node 504, such as for example, via an unsolicited publish message in a pub-sub protocol. The using entity of the monitored node 502 can identify the monitoring node 504 as a recipient of activity messages. The activity message 550 can be sent using an asynchronous protocol, such as for example, a publish command in a pub-sub protocol.

The activity message 550 can be sent as a notify message in response to a subscription message sent from the monitoring node 504 to the monitored node 502. The monitored node 502 can host a subscription service such as a pub-sub service, a Really Simple Syndication (RSS) service, or a proprietary service. Any suitable protocol can be used including HTTP, Extensible Messaging and Presence Protocol: Instant Messaging (XMPP-IM), Simple Object Access Protocol (SOAP), etc. A pub-sub protocol layer 414 and an HTTP layer 416 are illustrated in FIG. 4 as exemplary application layer protocols suitable for transmitting an activity message over a network via network stack 404 and communication interface 112.

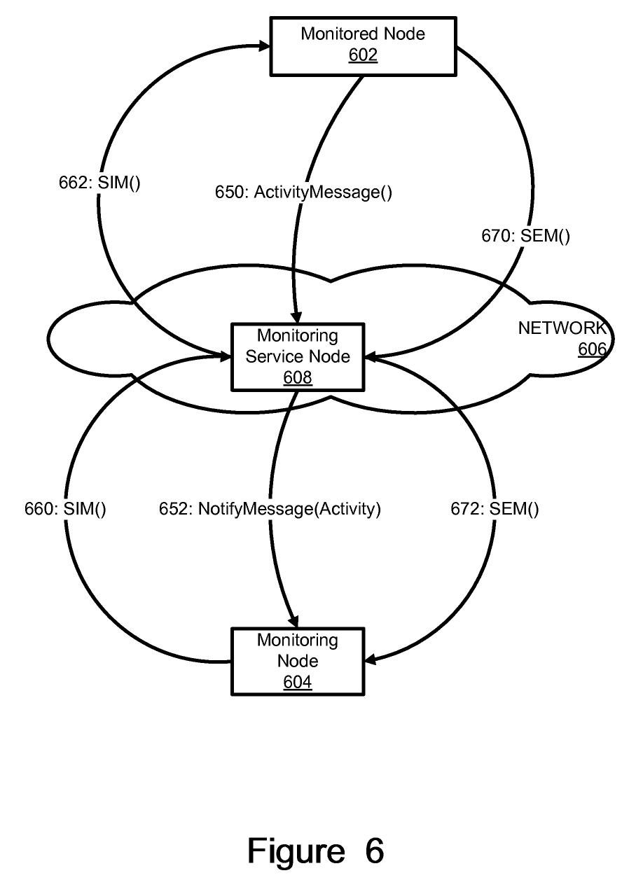

In the example illustrated in FIG. 6, the monitored node 602 sends the activity message to a proxy service, illustrated as a monitoring service node 608. A monitoring service node can host a pub-sub service node, an RSS server, or any service configured to receive the message 650 using a suitable protocol (asynchronous or synchronous). The monitoring service node 608 delivers the activity information in a message 652 based on the information in the activity message 650 to the monitored node 604. Message 652 can be sent by any suitable service hosted by the node 608 using any suitable protocol.

Returning to FIG. 2, in block 208 a session initiation message (SIM) is received requesting a co-browsing session with the monitoring node having received information based on the activity message. Accordingly, a system for establishing a shared browsing session between a user of a web browser with a user of another web browser includes means for receiving a SIM requesting a co-browsing session with the monitoring node having received information based on the activity message. For example, as illustrated in FIG. 3, a co-browsing agent component 306 is configured to receive a SIM requesting a co-browsing session with the monitoring node having received information based on the activity message.

The co-browsing agent 306 in FIG. 4 is illustrated as being a component of content manager component 418. In an alternative embodiment, the co-browsing agent component 306 can operate as a separate component. In some embodiments, a SIM can be received independent of the co-browsing agent component 306. The session initiation message (SIM) can be of any suitable format and/or protocol. In the execution environment illustrated in FIG. 4, a watcher component is configured to receive the SIM as a notification in a pub-sub protocol. The watcher component 432 is illustrated as a component of the co-browsing session layer 304 in FIG. 4. In an alternative embodiment, a watcher can operate as a separate component, operate as part of co-browsing agent 306, or operate as part of content manager 418.

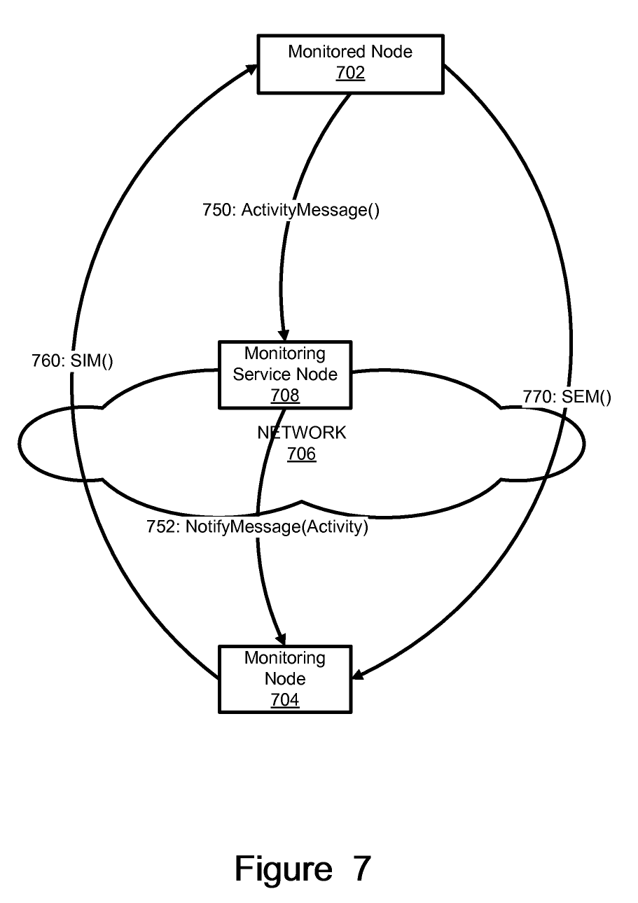

A SIM can be received from the monitoring node 504 addressed to the monitored node 502 as illustrated by the SIM 560 in FIG. 5 and the SIM 760 in FIG. 7. Additionally and/or alternatively, a SIM can be received via a proxy node as illustrated by the SIM 660 sent from the monitoring node 604 to monitoring service node 608 where it is received and relayed to the monitored node as shown by the SIM 662. The SIM 662 can be in a different message format than the format of SIM 660, the same format, and/or have the same or different protocol family. A SIM message can be received via a network 506, 606, 706 by a communication interface 112 of the execution environment 402. The SIM message is received by the co-browsing agent component 306 via the network stack 404 (and optionally an application protocol layer such as HTTP layer 420 and pub-sub layer 422). The co-browsing agent component 306 may be configured to relay the SIM to remote activity monitor 308 and/or activity widget handler 310.

Returning to FIG. 2, in block 210 in response to receiving the session initiation message, a session establish message (SEM) is sent for establishing the requested co-browsing session with the monitoring node. Accordingly, a system for establishing a shared browsing session between a user of a web browser with a user of another web browser includes means for sending, in response to receiving the SIM, a SEM for establishing the requested co-browsing session with the monitoring node. For example, as illustrated in FIG. 3, the co-browsing session layer component 304 is configured to send, in response to receiving the SIM, a SEM for establishing the requested co-browsing session with the monitoring node.

At the direction of the co-browsing agent component 306, the co-browsing session layer component 304 can send a SEM to establish a co-browsing session with the monitoring node 504, 604, 704. A SEM can be sent from the monitored node 502, 702 addressed to the monitoring node 502, 702 as illustrated by the SIM 570 in FIG. 5 and the SIM 770 in FIG. 7, respectively. Additionally and/or alternatively, a SEM can be sent via a proxy node as illustrated by the SEM 670 sent from the monitored node 602 to monitoring service node 608 where it is received and relayed to the monitoring node as shown by the SEM 672. The SEM 672 can be in a different message format than the format of SEM 670, the same format, and/or have the same or different protocol family. A SEM message can be received via a network 506, 606, 706 by a communication interface 112 of the execution environment 402. The SEM message is sent by the co-browsing session layer component 304 via the network stack 404 (and optionally an application protocol layer such as HTTP layer 420 and pub-sub layer 422).

The SEM can be automatically sent without user intervention. Alternatively, a widget handler in the presentation controller 408 can present a widget allowing the using entity to accept or reject the request. If the using entity accepts the request, the SEM is sent.

The SEM provides configuration settings for the co-browsing session. The configuration settings can be set by the monitored node and/or the monitoring node. In general, the monitored node has control over the configuration settings. If the co-browsing session is a two-way session, the configuration settings can also indicate how to pass “control” of the co-browsing session back and forth.

As the using entity of the monitored node continues to browse, the co-browsing session layer component 304 can be configured to generate update messages having updated current browsing information that associates the using entity with updated browsing activity. The update messages can be periodicially generated according to the configuration settings based on the session establish message. The using entity can start and stop the generation of update messages.

The update messages are sent for delivery to a monitoring node that has established a co-browsing session with the using entity. The update message can be sent without solicitation from the monitoring node 504. For example, the using entity of the monitored node 502 can identify the monitoring node 504 as a recipient of activity messages. The update message can be sent using an asynchronous protocol, such as for example, a publish command in a pub-sub protocol. The update message can be sent as a notify message in response to a subscription message sent from the monitoring node 504 to the monitored node 502.

The session establish message can specify the level of information and type of information provided in the activity message and in update messages. For example, the level of information can range from the site being browsed to pages being browsed within a site to actual commands entered by the using entity. The type of information can range from what device is being used, what applications are being used, who the using entity isto chatting with, etc.

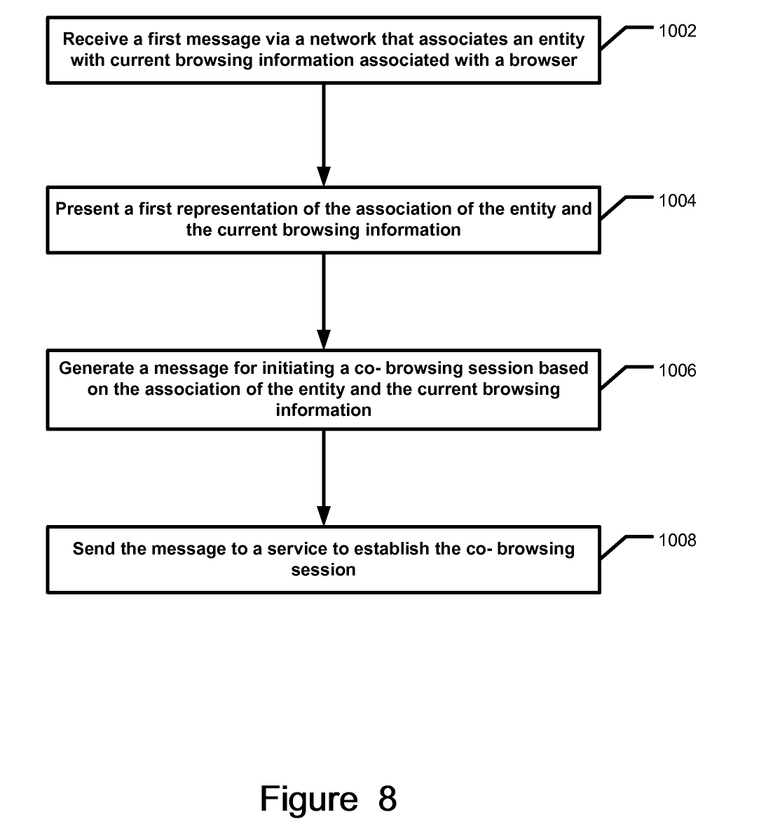

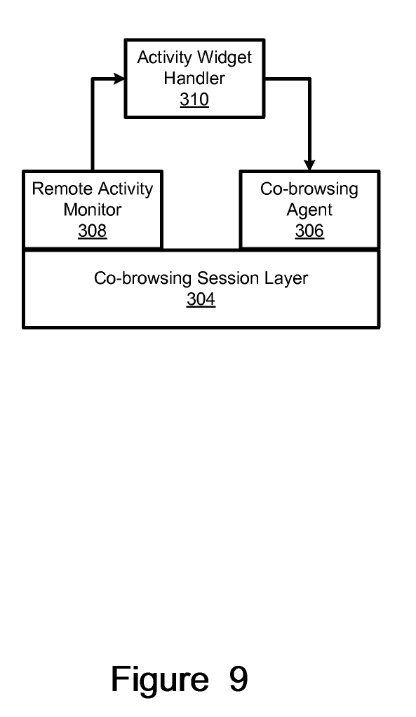

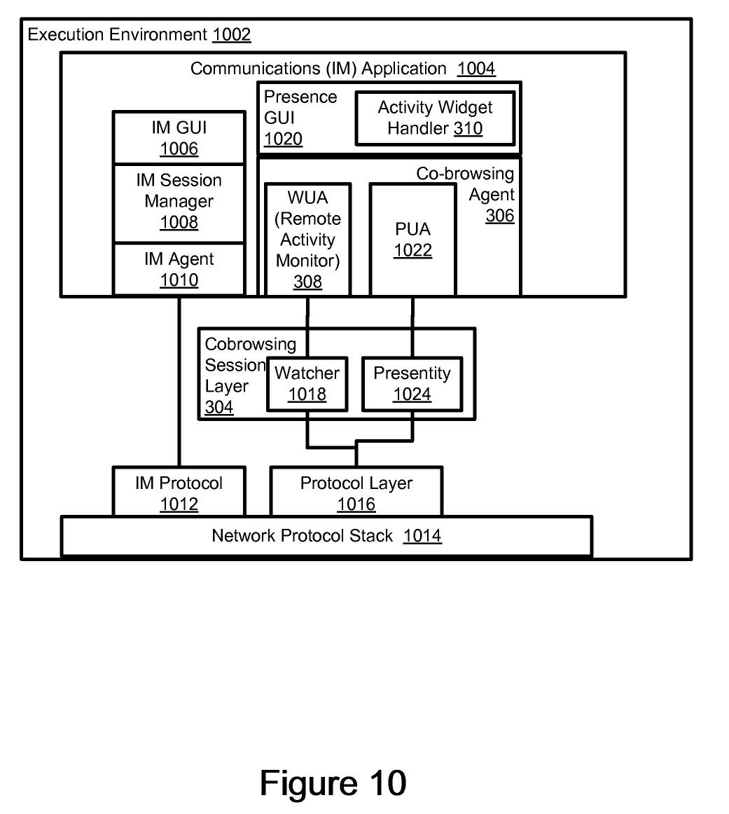

Turning now to FIG. 8, a flow diagram is illustrated illustrating a method for establishing a shared browsing session between a user of a web browser with a user of another web browser according to an exemplary aspect of the subject matter described herein. FIG. 9 is a block diagram illustrating an arrangement of components for establishing a shared browsing session between a user of a web browser with a user of another web browser according to another exemplary aspect of the subject matter described herein. FIG. 10 is a block diagram illustrating an arrangement of components providing an execution environment 1002 configured for hosting the arrangement of components depicted in FIG. 9. The method in FIG. 8 can be carried out by, for example, some or all of the components illustrated in the exemplary arrangement in FIG. 9 operating in an a compatible execution environment, such as the environment 1002 provided by some or all of the components of the arrangement in FIG. 10. The arrangement of components in FIG. 10 may be implemented by some or all of the components of the hardware device 100 of FIG. 1.

The execution environment 1002 includes a communications application 1004 that can include, in one embodiment, an arrangement of components for sending and receiving messages, such as instant messages (IMs). The arrangement includes an IM GUI 1006 for presenting messages and for receiving input for generating messages to be sent; an optional IM Session Manager 1008 for managing one or more ongoing communications sessions, and an IM agent 1010 for generating messages and for receiving messages from other clients. Messages are sent and received via a communication protocol layer, such as an IM protocol layer 1012, interoperating with a network stack 1014 interoperatively coupled to or part of a communication interface such as communication interface 112. IM is an exemplary form of communication that can be included in the communications application 1004. Other forms of communication that can be supported include voice, e.g., VoIP, video, email, MMS, SMS, FTP, and the like.

With reference to FIG. 8, in block 802 a first message is received via a network that associates an entity with current browsing information associated with a browser. Accordingly, a system for establishing a shared browsing session between a user of a web browser with a user of another web browser includes means for receiving a first message via a network that associates an entity with current browsing information associated with a browser. For example, as illustrated in FIG. 9, a remote activity monitor component 308 is configured to receive a first message via a network that associates an entity with current browsing information associated with a browser.

The remote activity monitor (RAM) component 308 is illustrated in FIG. 10 as a watcher user agent (WUA) of a presence system (e.g., a pub-sub system). The RAM component 308 can receive notification messages including browsing information from an activity message 550, 650 & 652, 750 & 752, sent by a monitored node 502, 602, 702. The execution environment 1002 can be hosted by a monitoring node such as nodes 504, 604, and 704.

The network stack 1014 illustrated in FIG. 10 is configured to interoperate with a communications interface such as communications interface 112 to receive the activity message. The information associating the entity and the current browsing information can be provided to the RAM component 308 via an application protocol layer 1016 such as presence or other pub-sub protocol layer to a watcher component 1018. The watcher 1018 can have a subscription established for watching the monitored node. The watcher component 1018 is illustrated as a component of the co-browsing session layer 304 in FIG. 10. In an alternative embodiment, a watcher can operate as a separate component.

The browser 406 (See FIG. 4) can also be hosted in the execution environment 402 of a monitoring node 504, 604, 704 including a RAM component 308. The RAM component 308 in FIG. 4 can be a WUA or any component configured to receive browsing information via an activity message in a suitable format via a suitable protocol over a network as previously described hereinabove.

Returning to FIG. 8, in block 804 a first representation of the association of the entity and the current browsing information is presented. Accordingly, a system for establishing a shared browsing session between a user of a web browser with a user of another web browser includes means for presenting a first representation of the association of the entity and the current browsing information. For example, as illustrated in FIG. 9, an activity widget handler component 310 is configured to present a first representation of the association of the entity and the current browsing information.

The RAM component 308 can be configured to provide the current browsing information associated with the browser of the browsing entity to an activity widget handler component 310. The activity widget handler component 310 can be configured to present a representation of the association of the entity and the current browsing information via a presentation interface (visual, audio, etc.) of an application such as the presence GUI 1020. The entity is identified in the presentation. The entity can be identified by a user alias, a group identifier (e.g., administer group member), etc.

In the embodiment illustrated in FIG. 4, the RAM component 308 can be configured to provide the association information to an activity widget handler component 310 of the browser 406. The activity widget handler component 310 can interoperate with the presentation controller component 408 to present a first representation of the association via the GUI manager 410 and output subsystem 412.

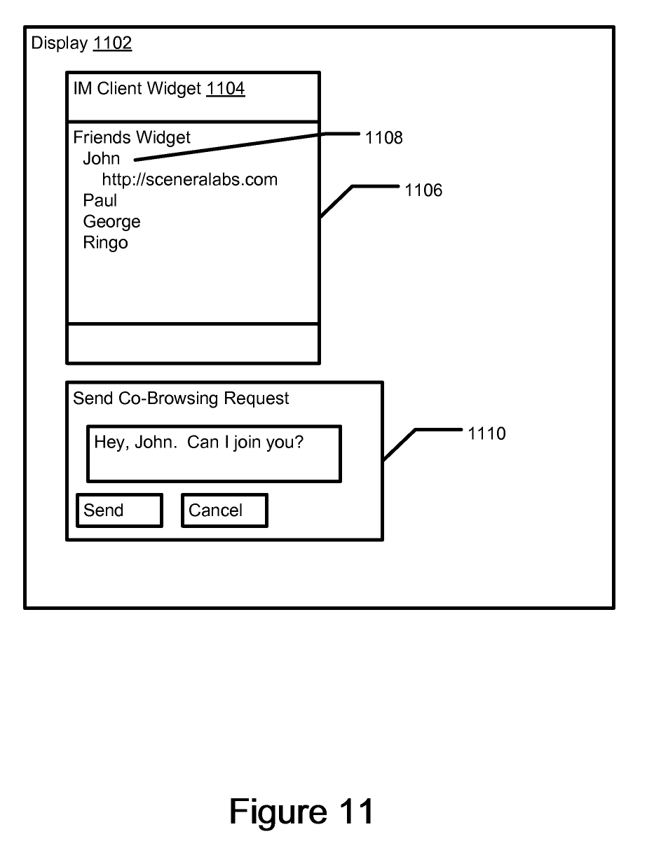

FIG. 11 illustrates a display 1102 of a monitoring node 504, 604, 704 presenting an IM Client Widget 1104 presented by the presence GUI component 1020. The IM Client Display includes a Friends Widget 1106. A representation 1108 of an association between a user entity identified by “John” and browsing information “http://sceneralabs.com” is presented by the activity widget handler component 310 as described above.

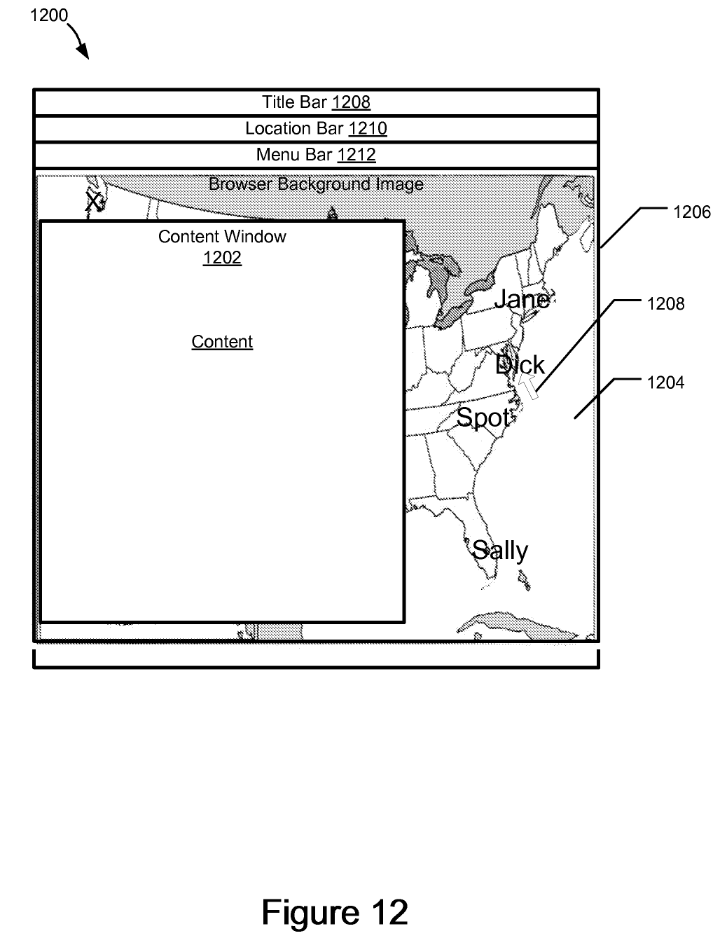

FIG. 12 illustrates a browser GUI 1200 that can be presented by the browser 406. The browser GUI 1200 includes a content window 1202 presented by a page/tab widget handler component 414 presenting content from a resource, such as, for example, a service provider. A map 1204 is presented in a map widget 1206 presented by a map widget handler component 428 as a background window for the content window 1202. An arrow icon 1208 is presented as a visual indicator over a representation of a user entity associated with the map. Representations of user entities “Dick”, “Jane”, “Sally”, and “Spot” are presented by the activity hander widget component 310 interoperating with the map widget handler component 428. Each user entity is associated with a location included in browser information and the association is illustrated on the map 1204. The location can be the location of a web site or application currently being accessed by each entity or can be the location from which each entity is browsing. The browser GUI 1200 illustrates a number of widgets typically presented by a web browser, such as a browser 406, or other browsing enabled application. The browser GUI 1200 can be presented via presentation controller component 408 in the browser 406. The presentation controller component 406 can be configured to coordinate the presentation of one or more widgets generated and managed by corresponding widget handlers that can be created, deleted, and otherwise managed by a widget manager component 416 interoperating with the presentation controller component 408 and other components in the browser 406 and the execution environment 402 and components of FIG. 1.

In the browser GUI 1200, a map 1204 is presented in a presentation space of map widget 1206 that is generated and managed by an instance of the map widget handler component 428. The map widget 1204 can be a type of a page/tab widget generated and managed by an instance of the page/tab widget handler component 414. Thus, in one embodiment, the map widget handler component 428 can be a type or subclass of the page/tab widget handler component 414. Alternatively, a map widget can be presented in a presentation space of a page/tab widget.

The browser GUI 1200 also illustrates a title bar widget 1208, a location bar widget 1210, and a menu bar widget 1212 that are well-known to current browser users. Each can be generated and managed by a corresponding instance of a widget handler component managed by the widget manager component 416.

Presentation on a display such as display 132 can be coordinated by the presentation controller component 408 interoperating with a GUI manager component 410 included in the execution environment 402. The GUI manager component 410 can be configured to direct the output subsystem 412 to present the widgets on a display as directed by corresponding widget handler components.

The site an entity is currently browsing and location information are two of many attributes that can be detected as current browsing information and associated with an entity interoperating with a browser. Other attributes can be the activity the entity is performing (e.g., shopping), user identity, purpose of the site the entity is browsing, information needed to fill out a form, etc.

Returning to FIG. 8, in block 806 a message for initiating a co-browsing session is generated based on the association of the entity and the current browsing information. Accordingly, a system for establishing a shared browsing session between a user of a web browser with a user of another web browser includes means for generating a message for initiating a co-browsing session based on the association of the entity and the current browsing information. For example, as illustrated in FIG. 9, a co-browsing agent component 308 is configured to generate a message for initiating a co-browsing session based on the association of the entity and the current browsing information.

The co-browsing agent component 308 generates a SIM (560, 660 & 662, 760) based on the association of the entity and the current browsing information. The current browsing information can identify an address of the monitored node 502, 602, 702 with which the co-browsing session is to be initiated or a monitoring service node 608. Alternatively, the entity can identify a tuple provided by a pub-sub service operating as a monitoring service or can otherwise identify an address identifying the recipient of the generated message. The SIM can be generated based on the tuple.

In FIG. 11 a “Send Co-Browsing Request” widget 1110 is presented. The widget 1110 can be presented in response to an input received in correspondence with the representation of the association 1108. The widget 1110 as illustrated allows the sender to optionally enter a message to send to the monitored node 502, 602, 702. In response to input corresponding to the send button, the co-browsing agent component 306 can be invoked by the activity widget handler component 310 to generate the message. In the embodiment illustrated in FIG. 10, a PUA component 1022 is configured to generate the message on behalf of the co-browsing agent component 306. In the embodiment illustrated in FIG. 4, the activity widget handler component 310 can invoke the co-browsing agent component 306 directly (or a PUA in another aspect) to generate the message.

Returning to FIG. 8, in block 808 the message is sent to a service to establish the co-browsing session. Accordingly, a system for establishing a shared browsing session between a user of a web browser with a user of another web browser includes means for sending the message to a service to establish the co-browsing session. For example, as illustrated in FIG. 9, the co-browsing session layer component 310 is configured to send the message to a service to establish the co-browsing session.

The co-browsing agent component 306 can provide the generated message to the co-browsing session layer 304 to send to a service to establish the shared browsing session. The service can be hosted by one or more of the monitored and/or monitoring nodes, a monitoring service node, and/or a separate service configured for hosting co-browsing sessions. The message can be sent using a suitable format and protocol as previously described. For example, FIG. 10 illustrates a presentity component 1024 for sending the message via a pub-sub protocol as previously described herein.

As the using entity of the monitored node continues to browse, the remote activity monitor component 308 can be configured to receive update messages including updated current browsing information that associates the using entity with updated browsing activity. The activity widget handler component 310 updates the first representation with a second representation based on the assocation between the entity and the updated current browsing information.

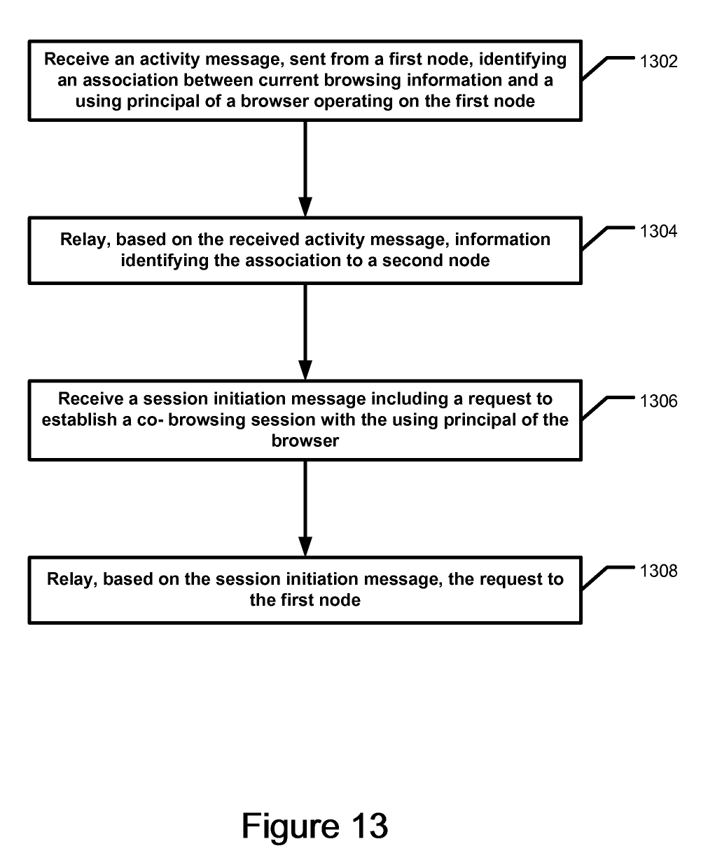

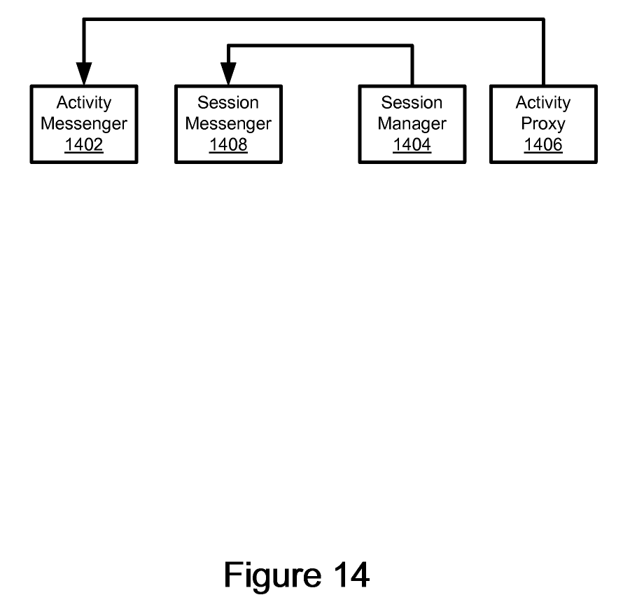

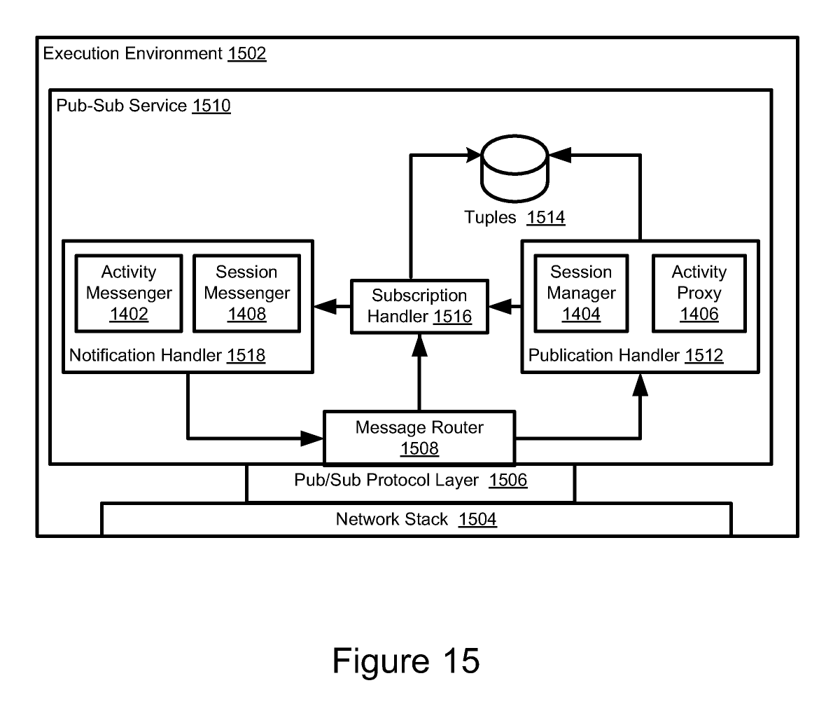

Turning now to FIG. 13, a flow diagram is illustrated illustrating a method for establishing a shared browsing session between a user of a web browser with a user of another web browser according to an exemplary aspect of the subject matter described herein. FIG. 14 is a block diagram illustrating an arrangement of components for establishing a shared browsing session between a user of a web browser with a user of another web browser according to another exemplary aspect of the subject matter described herein. FIG. 15 is a block diagram illustrating an arrangement of components providing an execution environment 1502 configured for hosting the arrangement of components depicted in FIG. 14. The method in FIG. 13 can be carried out by, for example, some or all of the components illustrated in the exemplary arrangement in FIG. 14 operating in an a compatible execution environment, such as the environment provided by some or all of the components of the arrangement in FIG. 15. The arrangement of components in FIG. 15 may be implemented by some or all of the components of the hardware device 100 of FIG. 1.

FIG. 15 illustrates a pub-sub service 1510, such as a presence service, operating in the execution environment 1502. The execution environment 1502 may reside on the monitoring service node 608. In the execution environment 1502, the pub-sub service 1510 is configured to process subscriptions by presence clients to information published by other presence clients. The pub-sub service 1510 includes means for receiving and processing presence commands, e.g., subscribe and publish commands, from the presence protocol layer 1506, means for handling subscribe commands, means for handling publish commands, and means for handling notification messages. Messages are received asynchronously via a network stack 1504 that routes the message to the presence protocol layer 1506. The presence protocol layer 1506 then passes the message to a message router 1508 of the pub-sub service 1510. The pub-sub protocol layer 1506 provides the functionality of publish, subscribe, and notify commands as previously described.

The message router component 1508 determines if the message is a publish message and passes the message content to a publication handler component 1512 if the message is a publish message to process the publish message. The publication handler component 1512 is operatively coupled to a tuples data store 1514 for storing presence and messaging information. In one embodiment, the publication handler component 1512 is configured to identify and process presence information that includes the status value in a publish message. In one embodiment, the publication handler component 1512 can use the presence information to update or create a tuple identified in the message. Depending on the nature of the command, the publication handler component 1512 can also pass the presence information directly to specified recipients via a directed notify command using the notification handler component 1518, or can pass the presence information to currently subscribed clients using a subscription handler component 1516 and notification handler component 1518.

The pub-sub service 1510 can include a subscription handler component 1516 operatively coupled to the publication handler component 1512 and to the tuples data store 1514. The subscription handler component 1516 is configured to process subscribe commands and other tasks associated with subscriptions. The subscription handler component 1516 can also be configured to determine when notifications are to be transmitted to client devices, as detected through events generated by the publication handler component 1512 or by the tuples data store 1514.

The tuples data store 1514 can store tuple data and/or other data such as subscription information. The data and information can be treated as tuple data meaning that is can be formatted for transfer using a data format compatible with the pub-sub communication protocol supported by the pub-sub service 1510.

The pub-sub service 1510 can also include means for asynchronously sending a notification including, for example, presence status and/or at least a portion of a message to a client of the pub-sub service 1510 in conformance with the appropriate format, such as a notification handler component 1518, operatively coupled to the subscription handler component 1516 and the message router component 1506. On instruction from subscription handler component 1516, the notification handler component 1518 is configured to format the information for inclusion in the notify message. The notification handler component 1518 can be further configured to track the delivery status of notifications that have been sent and can support resending notifications to assure delivery to clients of the pub-sub service 1510.

The message router component 1506 is configured to route publish and notify commands between the publication component handler 1512 and notification handler component 1518 and the clients of the pub-sub service 1510. The router component 1506 interfaces with the pub-sub protocol layer 1504 to send notification messages and to receive publish and subscribe messages to and from clients such as client nodes 602, 604.

With reference to FIG. 13, in block 1302, based on a received activity message sent from a first node, information is relayed to a second node that identifies an association between current browsing information and a using principal of a browser operating on the first node. Accordingly, a system for establishing a shared browsing session between a user of a web browser with a user of another web browser includes means for relaying, based on a received activity message sent from a first node, information to a second node, the information identifying an association between current browsing information and a using principal of a browser operating on the first node. For example, as illustrated in FIG. 14, an activity messenger component 1402 is configured to relay, based on a received activity message sent from a first node such as node 602, information to a second node such as node 604, the information identifying an association between current browsing information and a using principal of a browser operating on the first node.

The activity message is received by an activity proxy component 1406. In the execution environment 1502, the activity proxy component 1406 can be a component of the publication handler component 1512, a separate component in the pub-sub service 1510, or a separate component in communication with the pub-sub service 1510. In the execution environment 1502, the activity proxy component 1406 can be configured to asynchronously receive the activity message as a publish message. The activity proxy component 1406 relays the activity message to the activity messenger component 1402 to relay the activity message to the second node.

In the execution environment 1502, the activity messenger component 1402 may be part of the notification handler component 1518 in the pub-sub service 1510. Alternatively, the activity messenger component 1402 may be a separate component or part of another component in the pub-sub service 1510 or a separate component in communication with the pub-sub service 1510. In the execution environment 1502, the activity messenger component 1402 can be configured to relay the information that identifies an association between current browsing information and a using principal of a browser operating on the first node to the second node in one or more notification messages as described above.

Returning to FIG. 13, in block 1304 a session initiation message is received including a request to establish a co-browsing session with the using principal of the browser. Accordingly, a system for establishing a shared browsing session between a user of a web browser with a user of another web browser includes means for receiving a session initiation message including a request to establish a co-browsing session with the using principal of the browser. For example, as illustrated in FIG. 14, a session manager component 1404 is configured to receive a session initiation message including a request to establish a co-browsing session with the using principal of the browser.

In the execution environment 1502, the session manager component 1404 may be part of the publication handler component 1512 in the pub-sub service 1510. Alternatively, the session manager component 1404 may be a separate component or part of another component in the pub-sub service 1510 or a separate component in communication with the pub-sub service 1510. In the execution environment 1502, the session manager component 1404 is configured to asynchronously receive the session initiation message as a publish message. In the example illustrated in FIG. 6, the monitoring service node 608 can incorporate the execution environment 1502 and the monitoring node 604 sends the session initiation message to the monitoring service node 608.

Returning to FIG. 13, in block 1306, based on the session initiation message, the request is relayed to the first node. Accordingly, a system for establishing a shared browsing session between a user of a web browser with a user of another web browser includes means for relaying, based on the session initiation message, the request to the first node. For example, as illustrated in FIG. 14, the session manager component 1404 is configured to relay, based on the session initiation message, the request to the first node.

In the execution environment 1502, the session manager component 1404 relays the request to the notification handler component 1518 and/or the activity messenger component 1402 to send the request to the second node.

Returning to FIG. 13, in block 1308 a session establish message, sent from the first node, is relayed to the second node to configure the requested co-browsing information, the session establish message including session establishment information for configuring the requested co-browsing session. Accordingly, a system for establishing a shared browsing session between a user of a web browser with a user of another web browser includes means for relaying a session establish message, sent from the first node, to the second node to configure the requested co-browsing information, the session establish message including session establishment information for configuring the requested co-browsing session. For example, as illustrated in FIG. 14, the activity messenger component 1402 is further configured to relay a session establish message, sent from the first node, to the second node to configure the requested co-browsing information, the session establish message including session establishment information for configuring the requested co-browsing session.

The session establish message is received by the activity proxy component 1406. In the execution environment 1502, the activity proxy component 1406 can be configured to asynchronously receive the session initiation message as a publish message. The activity proxy component 1406 relays the session establish message to the activity messenger component 1402 to relay the session establish message to the second node. In the execution environment 1502, the activity messenger component 1402 can be configured to relay the session establish message to the second node in one or more notification messages as described above.

The session establishment information included in the session establish message contains information for configuring the requested co-browsing session. The information includes an identification of the protocol for sending and receiving messages, at least one format for sending and receiving messages, addresses of the nodes, etc. The information also depends on the type of co-browsing session. For example, in a co-browsing session where the first node and the second node both lead the co-browsing session, the information includes how control is passed back and forth between the principals using browsers on the nodes.

Returning to FIG. 13, in block 1310 current browser information of the using principal, sent from the first node, is relayed to the second node. Accordingly, a system for establishing a shared browsing session between a user of a web browser with a user of another web browser includes means for relaying current browser information of the using principal, sent from the first node, to the second node. For example, as illustrated in FIG. 14, a session messenger component 1408 is configured to relay current browser information of the using principal, sent from the first node, to the second node.

In the execution environment 1502, the session messenger component 1408 may be part of the notification handler component 1518 in the pub-sub service 1510. Alternatively, the session messenger component 1408 may be a separate component or part of another component in the pub-sub service 1510 or a separate component in communication with the pub-sub service 1510. In the execution environment 1502, the session messenger component 1408 can be configured to relay the information that identifies an association between current browsing information and a using principal of a browser operating on the first node to the second node in one or more notification messages as described above.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for establishing a shared browsing session between a user of a web browser with a user of another web browser, the method comprising:
relaying, based on a received activity message sent from a first node, information to a second node, the information identifying an association between current browsing information and a using principal of a browser operating on the first node;
receiving a session initiation message including a request to establish a co-browsing session with the using principal of the browser;
relaying, based on the session initiation message, the request to the first node;
relaying a session establish message, sent from the first node, to the second node to configure the requested shared browsing information, the session establish message including session establishment information for configuring the requested co-browsing session; and
relaying current browser information of the using principal, sent from the first node, to the second node,
wherein at least one of the preceding actions is performed on at least one electronic hardware component.

2. The method of claim 1 wherein each activity message and session initiation message received is received via an asynchronous protocol.

3. The method of claim 2 wherein the asynchronous protocol is a publish-subscribe protocol.

4. The method of claim 1 further comprising receiving the session establish message from the first node.

5. The method of claim 1 further comprising receiving the received activity from the first node.

6. The method of claim 1 wherein the session establishment information includes an identification of a protocol for sending and receiving messages, a format for sending and receiving messages, and an address of at least one of the first node and the second node.

7. The method of claim 1 wherein the first node is a monitored node and the second node is a monitoring node.

8. A system for establishing a shared browsing session between a user of a web browser with a user of another web browser, the system comprising:
means for relaying, based on a received activity message sent from a first node, information to a second node, the information identifying an association between current browsing information and a using principal of a browser operating on the first node;
means for receiving a session initiation message including a request to establish a co-browsing session with the using principal of the browser;
means for relaying, based on the session initiation message, the request to the first node;
means for relaying a session establish message, sent from the first node, to the second node to configure the requested co-browsing information, the session establish message including session establishment information for configuring the requested co-browsing session; and
means for relaying current browser information of the using principal, sent from the first node, to the second node,
wherein at least one of the means includes at least one electronic hardware component.

9. A system for establishing a shared browsing session between a user of a web browser with a user of another web browser, the system comprising system components including:
an activity messenger component configured to relay, based on a received activity message sent from a first node, information to a second node, the information identifying an association between current browsing information and a using principal of a browser operating on the first node;
a session manager component configured to receive a session initiation message including a request to establish a co-browsing session with the using principal of the browser, the
session manager component further configured to relay, based on the session initiation message, the request to the first node, the
activity messenger component configured to relay a session establish message, sent from the first node, to the second node to configure the requested co-browsing information, the session establish message including session establishment information for configuring the requested co-browsing session; and
a session messenger component configured to relay current browser information of the using principal, sent from the first node, to the second node,
wherein at least one of the system components includes at least one electronic hardware component.

10. The system of claim 9 wherein each activity message and session initiation message received is received via an asynchronous protocol.

11. The system of claim 10 wherein the asynchronous protocol is a publish-subscribe protocol.

12. The system of claim 9 further comprising an activity proxy component configured to receive the session establish message from the first node.

13. The system of claim 12 wherein the activity proxy component is further configured to receive the received activity from the first node.

14. The system of claim 9 wherein the session establishment information includes an identification of a protocol for sending and receiving messages, a format for sending and receiving messages, and an address of at least one of the first node and the second node.

15. The system of claim 9 wherein the first node is a monitored node and the second node is a monitoring node.

16. A computer readable medium storing a computer program, executable by a machine, for establishing a shared browsing session between a user of a web browser with a user of another web browser, the computer program comprising executable instructions for:
relaying, based on a received activity message sent from a first node, information to a second node, the information identifying an association between current browsing information and a using principal of a browser operating on the first node;
receiving a session initiation message including a request to establish a co-browsing session with the using principal of the browser;
relaying, based on the session initiation message, the request to the first node;
relaying a session establish message, sent from the first node, to the second node to configure the requested co-browsing information, the session establish message including session establishment information for configuring the requested co-browsing session; and
relaying current browser information of the using principal, sent from the first node, to the second node.

17. The computer readable medium of claim 16 wherein each activity message and session initiation message received is received via an asynchronous protocol.

18. The computer readable medium of claim 17 wherein the asynchronous protocol is a publish-subscribe protocol.

19. The computer readable medium of claim 16 wherein the computer program comprises further executable instructions for further comprising receiving the session establish message from the first node.

20. The computer readable medium of claim 16 wherein the computer program comprises further executable instructions for receiving the received activity from the first node.

21. The computer readable medium of claim 16 wherein the session establishment information includes an identification of a protocol for sending and receiving messages, a format for sending and receiving messages, and an address of at least one of the first node and the second node.

22. The computer readable medium of claim 16 wherein the first node is a monitored node and the second node is a monitoring node.
